(19) United States
(12) Patent Application Publication
(10) Pub. No.: US 2025/0076173 A1
(43) Pub. Date: Mar. 6, 2025

(54) Method of Utilizing Optical Path Difference in Two-phase Flow for Analytical Calculation of Particle Size Gradation and Solid Content

(71) Applicant: Dandong Bettersize Instruments Ltd., Dandong City, Liaoning Province (CN)

(72) Inventors: Jilai FAN, Dandong (CN); Chuang LI, Dandong (CN); Xiaoxu LI, Dandong (CN); Hao CHEN, Dandong (CN); Sen HU, Dandong (CN); Mingfeng WU, Dandong (CN); Xiaodong ZHOU, Dandong (CN)

(21) Appl. No.: 18/575,245

(22) PCT Filed: Mar. 22, 2023
(86) PCT No.: PCT/CN2023/083037

§ 371 Date: Dec. 28, 2023

(30) Foreign Application Priority Data
Mar. 9, 2023 (CN) 202310226531.1

(51) Int. Cl. G01N 15/0205; G01N 15/00

(52) U.S. Cl. CPC G01N 15/0211; G01N 2015/0053

(57) ABSTRACT

A method utilizing optical path difference in two-phase flow for analytical calculation of particle size gradation and solid content comprises: changing a width of measurement area of a laser particle size analyzer, and collecting extinction values at two different optical path lengths and a scattered light intensity signal on each detector during monitoring; utilizing the scattered light intensity signal with a long optical path to subtract the scattered light intensity signal with a short optical path on each detector to obtain a set of new scattered light intensity signals with background subtracted; processing particle size distribution inversion calculations for the set of scattered light intensity signals with background subtracted to obtain gradation data of solid particles; processing subtraction of the logarithm of the extinction value of the short optical path from the logarithm of the extinction value of the long optical path to obtain new extinction value; calculating the solid content based on the new extinction value related data and the gradation data obtained. Neither the measured scattered light intensity signal of particle gradation nor the extinction value signal of measured solid content is affected by window lens contamination. A pure scattered light intensity signal can be obtained without measuring the background signal in the pure medium state. The long-term real-time underwater or atmospheric monitoring is realized.

### FIELD OF INVENTION

The present invention relates to the field of underwater sand content and particle size grading monitoring, and is related to a method of utilizing optical path difference in two-phase flow for analytical calculation of particle size gradation and solid content.

### DESCRIPTION OF RELATED ARTS

In hydrological monitoring work, the particle gradation and sand content analysis of sediment in rivers, oceans, and ports is an important task, which is of great significance for preventing soil erosion, sand discharge and siltation prevention in dam maintenance, and river and waterway regulation and dredging.

Sediment in rivers belongs to two-phase flow of liquid-solid. From the measurement process and application, there are two aspects in the current underwater online laser particle size analyzer, the sand content and particle size gradation monitoring instrument where there are drawbacks that affect the actual application effect. First, because river water is not a pure medium environment, the background signal of the instrument cannot be measured in real time but a fixed background signal is used as a penalty, which will have a certain impact on collecting the actual scattering signal of sediment. Second, contamination will occur if the test window lens is immersed in water for a long time, and there will be certain errors in the measured extinction value and scattering signal, which will affect the accuracy of the calculation results of particle size gradation and solid content.

Particulate matter in the air also belongs to two-phase flow of gas-solid, and its quality monitoring also has the same drawbacks as two-phase flow of liquid-solid monitoring. Therefore, there is an urgent need for a method with higher accuracy and more convenient to use to improve the monitoring accuracy of particle size gradation and solid content in two-phase flow.

### SUMMARY OF THE PRESENT INVENTION

An object of the present invention is to provide a method utilizing optical path difference in two-phase flow for analytical calculation of particle size gradation and solid content to solve the problem of errors in the calculation of particle size gradation and solid content caused by the use of fixed background signals and contamination of the test window lens (of the laser particle size analyzer).

According to the present invention, a method utilizing optical path difference in two-phase flow for analytical calculation of particle size gradation and solid content comprises the following steps:
Step 1: Changing a width of measurement area of a laser particle size analyzer, and collecting extinction values at two different optical path lengths and a scattered light intensity signal on each detector during monitoring;
Step 2: the scattered light intensity signal with a short optical path is subtracted from the scattered light intensity signal with a long optical path on each detector to obtain a set of new scattered light intensity signals with background subtracted;
Step 3: processing particle size distribution inversion calculations for the set of scattered light intensity signals with background subtracted to obtain gradation data of solid particles;
Step 4: Processing subtraction of the logarithm of the extinction value of the short optical path from the logarithm of the extinction value of the long optical path to obtain new extinction value related data;
Step 5: Processing calculation of the solid content based on the new extinction value related data and the gradation data obtained from the above steps.

According to the method utilizing optical path difference in two-phase flow for analytical calculation of particle size gradation and solid content of the present invention, in step 2, the new scattered light intensity signals on the detector is calculated by the followings:

$$S = {A}_{1} - {A}_{2} = ( {S}_{1} + B ) - ( {S}_{2} + B ) = {S}_{1} - {S}_{2}$$

wherein A₁ refers to a scattered light intensity signal with long optical path and background on the detector, A₂ refers to a scattered light intensity signal with short optical path and background on the detector, B refers to the background signal, S₁ refers to a scattered light intensity signal with long optical path after the background is subtracted, S₂ refers to a scattered light intensity signal with short optical path after the background is subtracted, S refers to a scattered light intensity signal difference for scattered light intensity signal with different optical paths, that is, the new scattered light intensity signal; the new scattered light intensity signal on each detector constitutes a new set of scattered light intensity signals.

According to the method utilizing optical path difference in two-phase flow for analytical calculation of particle size gradation and solid content of the present invention, in step 4, the specific calculation of the new extinction value is:

$$ln ( \frac{{I}_{1}}{{I}_{0}} ) = - \frac{3 {C}_{v} {L}_{1} {K}_{ext}}{2 D}$$

$$ln ( \frac{{I}_{2}}{{I}_{0}} ) = - \frac{3 {C}_{v} {L}_{2} {K}_{ext}}{2 D}$$

$$ln ( \frac{{I}_{1}}{{I}_{0}} ) - ln ( \frac{{I}_{2}}{{I}_{0}} ) = - \frac{3 {C}_{v} {L}_{1} {K}_{ext}}{2 D} + \frac{3 {C}_{v} {L}_{2} {K}_{ext}}{2 D} = - \frac{3 {C}_{v} {K}_{ext}}{2 D} ( {L}_{1} - {L}_{2} )$$

Wherein I₁ refers to transmitted signal for long optical path, I₂ refers to transmitted signal for short optical path, I₀ refers to the initial light intensity signal, D refers to the surface area mean diameter of the solid particles calculated by the scattered light intensity inversion in step 3, and Kext refers to the extinction coefficient, L₁ refers to a length of the long optical path, L₂ refers to a length of the short optical path, Cv refers to a volume concentration of solid particles.

According to the method utilizing optical path difference in two-phase flow for analytical calculation of particle size gradation and solid content of the present invention, in step 5, the solid content H is calculated according to the following formula:

$$H = {C}_{v} \times ρ = - \frac{[ ln ( \frac{{I}_{1}}{{I}_{0}} ) - ln ( \frac{{I}_{2}}{{I}_{0}} ) ] 2 D}{3 {K}_{ext} ( {L}_{1} - {L}_{2} )} \times ρ$$

Wherein ρ refers to a density of solid particle.

The method utilizing optical path difference in two-phase flow for analytical calculation of particle size gradation and solid content at least has the following advantageous effect:

The scattered signals with long optical path and short optical path are both scattered signals with background. When they are compared, it is equivalent to subtracting the background from the two scattered signals with background. The remaining signal is the difference in intensity of the scattered signal, which is also the scattered signal of the group of particles in the two-phase flow system and completely contains the particle size distribution information. If the window lens (of the laser particle size analyzer) is contaminated, then the scattered signal generated by the contaminant is in the background and can be completely subtracted. The resulting scattered signal is the true scattered signal of the sediment in the two-phase flow. The extinction value is also measured by subtracting the extinction value under the short optical path from the extinction value under the long optical path. In this way, due to the contamination of the window lens (of the laser particle size analyzer), the part of the extinction value that is not caused by sediment particles will be subtracted, and the extinction value will not be affected by the contamination of window lenses.

The present invention is not affected by window lens contamination (of the laser particle size analyzer), whether it is the measured the scattered light intensity signal of particle gradation or the extinction value signal of measured solid content, and can obtain simple and pure scattered light intensity signal without the step of measuring the background signal in pure medium, thereby realizing a long-term operation of underwater or atmospheric online monitoring (through the laser particle size analyzer).

### BRIEF DESCRIPTION OF THE DRAWINGS

FIG. 1 is a flowchart of method utilizing optical path difference in two-phase flow for analytical calculation of particle size gradation and solid content according to the present invention.

FIG. 2 is a particle size distribution diagram obtained based on Mie scattering theory.

### DETAILED DESCRIPTION OF THE PREFERRED EMBODIMENT

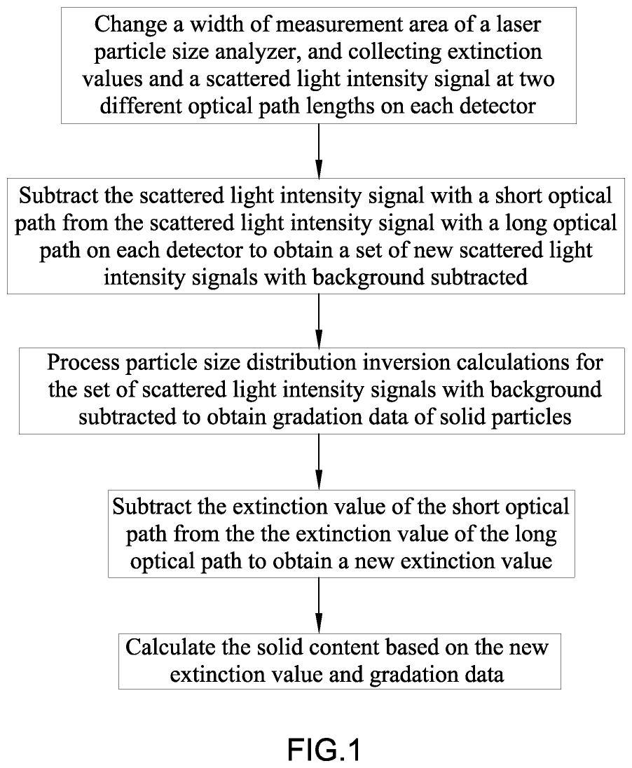

Referring to FIG. 1, a method utilizing optical path difference in two-phase flow for analytical calculation of particle size gradation and solid content according to the present invention comprises the following steps:

Step 1: The width of measurement area of a laser particle size analyzer is changed. During monitoring, the extinction values at two different optical path lengths and a scattered light intensity signal on each detector are collected.

According to this embodiment, as shown in Table 1, the collected scattered light intensity distributions at two different optical path lengths are as follows

| | | Difference |
|---|---|---|
| | | Calculation |
| Length of Measurement | Length of Measurement | Extinction Value |
| Area: 2 mm Optical Path | Area: 3 mm Optical Path | Difference=− |
| Measured Extinction | Measured Extinction | Difference |
| Value ln(I₂/I0) = −0.0943 | Value ln(I₁/I0) = −0.287 | between the |
| The Scattered Light | The Scattered Light | Scattered Signals |
| Intensity of each | Intensity of each | of each |
| Detector is as follows: | Detector is as follows: | Detector is as |
| 5167.23 | 3588.963 | −1578.267 |
| 3956.379 | 3260.721 | −695.658 |
| 1534.273 | 1364.772 | −169.501 |
| 1001.801 | 909.718 | −92.083 |
| 548.776 | 513.048 | −35.728 |
| 490.915 | 450.363 | −40.552 |
| 354.166 | 331.968 | −22.198 |
| 333.446 | 309.917 | −23.529 |
| 280.98 | 266.197 | −14.783 |
| 270.817 | 257.28 | −13.537 |
| 241.91 | 235.644 | −6.266 |
| 248.5 | 245.216 | −3.284 |
| 237.408 | 240.078 | 2.67 |
| 260.722 | 268.173 | 7.451 |
| 259.116 | 274.643 | 15.527 |
| 272.375 | 295.618 | 23.243 |
| 292.769 | 325.546 | 32.777 |
| 328.452 | 373.51 | 45.058 |
| 383.206 | 443.302 | 60.096 |
| 427.557 | 505.911 | 78.354 |
| 523.84 | 628.434 | 104.594 |
| 601.167 | 730.885 | 129.718 |
| 689.158 | 848.572 | 159.414 |
| 802.222 | 999.399 | 197.177 |
| 944.272 | 1186.075 | 241.803 |
| 1097.906 | 1391.366 | 293.46 |
| 1296.674 | 1645.303 | 348.629 |
| 1514.234 | 1932.2 | 417.966 |
| 1762.493 | 2267.687 | 505.194 |
| 2043.676 | 2647.561 | 603.885 |
| 2359.548 | 3069.963 | 710.415 |
| 2654.656 | 3463.351 | 808.695 |
| 2941.415 | 3851.256 | 909.841 |
| 3631.194 | 4604.883 | 973.689 |
| 3483.78 | 4572.389 | 1088.609 |
| 3896.296 | 5083.865 | 1187.569 |
| 4161.654 | 5492.191 | 1330.537 |
| 4535.62 | 5984.344 | 1448.724 |
| 4965.422 | 6563.453 | 1598.031 |
| 5308.882 | 7008.687 | 1699.805 |
| 5715.995 | 7537.142 | 1821.147 |
| 6192.446 | 8062.983 | 1870.537 |
| 6415.429 | 8468.343 | 2052.914 |
| 6758.973 | 8871.968 | 2112.995 |
| 7041.008 | 9275.152 | 2234.144 |
| 7321.049 | 9634.642 | 2313.593 |
| 7599.674 | 10002.993 | 2403.319 |
| 7853.106 | 10327.616 | 2474.51 |
| 8054.424 | 10594.912 | 2540.488 |
| 8361.472 | 11011.056 | 2649.584 |
| 8699.398 | 11440.092 | 2740.694 |
| 9034.359 | 11891.172 | 2856.813 |
| 9366.257 | 12313.862 | 2947.605 |
| 9786.41 | 12867.667 | 3081.257 |
| 10131.857 | 13363.827 | 3231.97 |
| 10481.914 | 13843.943 | 3362.029 |
| 10888.937 | 14362.57 | 3473.633 |
| 11217.049 | 14871.9 | 3654.851 |
| 11489.425 | 15283.211 | 3793.786 |
| 11750.904 | 15701.206 | 3950.302 |
| 12036.368 | 16150.397 | 4114.029 |
| 12305.886 | 16663.214 | 4357.328 |
| 12468.702 | 16999.625 | 4530.923 |
| 12724.211 | 17504.46 | 4780.249 |
| 12783.646 | 17725.052 | 4941.406 |
| 12938.338 | 18047.344 | 5109.006 |
| 13229.308 | 18599.631 | 5370.323 |
| 13396.673 | 18970.73 | 5574.057 |
| 13583.191 | 19354.514 | 5771.323 |
| 13830.258 | 19772.346 | 5942.088 |
| 14019.414 | 20226.03 | 6206.616 |
| 14237.112 | 20583.46 | 6346.348 |
| 12258.941 | 17791.09 | 5532.149 |
| 11868.634 | 17245.083 | 5376.449 |
| 11496.996 | 16693.347 | 5196.351 |
| 10812.336 | 15682.237 | 4869.901 |
| 10083.973 | 14549.012 | 4465.039 |
| 9318.834 | 13421.222 | 4102.388 |
| 8500.133 | 12219.003 | 3718.87 |
| 7884.584 | 11274.975 | 3390.391 |
| 7032.316 | 10043.987 | 3011.671 |
| 6343.078 | 9034.326 | 2691.248 |
| 5460.253 | 7724.258 | 2264.005 |
| 4737.527 | 6678.556 | 1941.029 |
| 4119.438 | 5824.263 | 1704.825 |
| 3747.709 | 5303.985 | 1556.276 |
| 2893.277 | 3339.839 | 446.562 |
| 1503.234 | 1983.828 | 480.594 |
| 1137.452 | 1524.015 | 386.563 |
| 816.863 | 1115.841 | 298.978 |
| 534.471 | 737.838 | 203.367 |
| 283.284 | 385.478 | 102.194 |

Step 2: On each detector (of the laser particle size analyzer), subtracts the scattered light intensity signal with a short optical path from the scattered light intensity signals with a long optical path to obtain a set of new scattered light intensity signals with background being subtracted.

In specific implementation, the calculation process of the new scattered light intensity signal in step 2 is as follows:

$$S = {A}_{1} - {A}_{2} = ( {S}_{1} + B ) - ( {S}_{2} + B ) = {S}_{1} - {S}_{2}$$

wherein A₁ refers to a scattered light intensity signal with long optical path and background, A₂ refers to a scattered light intensity signal with short optical path and background, B refers to the background signal, S₁ refers to a scattered light intensity signal with long optical path after the background is subtracted, S₂ refers to a scattered light intensity signal with short optical path after the background is subtracted, S refers to a scattered light intensity signal difference for scattered light intensity signals with different optical paths, that is, the new scattered light intensity signal.

Step 3: For the new set of scattered light intensity signals, process particle size distribution inversion calculation to obtain gradation data of solid particles.

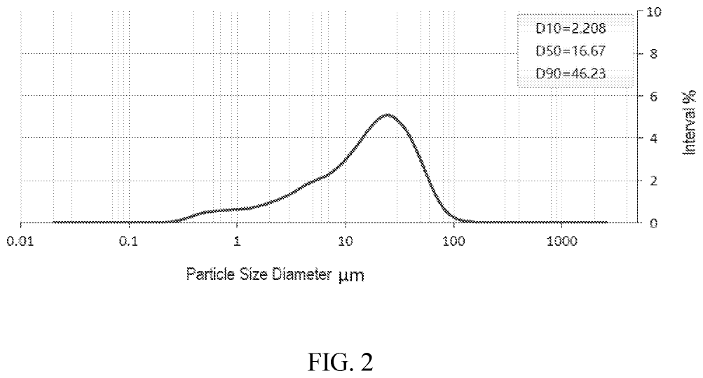

In specific implementation, through the new set of scattered light intensity signals, the particle size distribution is obtained according to Mie scattering theory, which is shown in FIG. 2 of the drawings. The typical characteristic values are calculated, which includes grading data such as volume mean diameter, surface area mean diameter, length mean diameter, number mean diameter, peak particle size diameter, specific surface area, span, and etc. The details are shown in Table 2 as follows:

| D00 | 0.205 | μm | volume mean | 21.15 | μm |
|---|---|---|---|---|---|
| | | | diameter D[4,3] | | |
| D10 | 2.208 | μm | surface area mean | 5.013 | μm |
| | | | diameter D[3,2] | | |
| D16 | 3.817 | μm | length mean | 0.936 | μm |
| | | | diameter D[2,1] | | |
| D25 | 6.599 | μm | number mean | 0.500 | μm |
| | | | diameter D[1,0] | | |
| D50 | 16.67 | μm | peak particle | 24.39 | μm |
| | | | size diameter | | |
| D75 | 30.37 | μm | specific surface | 443.2 | m²/kg |
| | | | area | | |
| D84 | 38.37 | μm | Span | 2.640 | |
| D90 | 46.23 | μm | | | |
| D100 | 151.1 | μm | | | |

Step 4: Process subtraction of the logarithm of the extinction value of the short optical path from the logarithm of the extinction value of the long optical path to obtain new extinction value. In particular, the calculation of the new extinction value is as follows:

$$ln ( \frac{{I}_{1}}{{I}_{0}} ) = - \frac{3 {C}_{v} {L}_{1} {K}_{ext}}{2 D}$$

$$ln ( \frac{{I}_{2}}{{I}_{0}} ) = - \frac{3 {C}_{v} {L}_{2} {K}_{ext}}{2 D}$$

$$ln ( \frac{{I}_{1}}{{I}_{0}} ) - ln ( \frac{{I}_{2}}{{I}_{0}} ) = - \frac{3 {C}_{v} {L}_{1} {K}_{ext}}{2 D} + \frac{3 {C}_{v} {L}_{2} {K}_{ext}}{2 D} = - \frac{3 {C}_{v} {K}_{ext}}{2 D} ( {L}_{1} - {L}_{2} )$$

Wherein I₁ refers to transmitted signal for long optical path, I₂ refers to transmitted signal for short optical path, I₀ refers to the initial light intensity signal, D refers to the surface area mean diameter of the solid particles calculated by the scattered light intensity inversion in step 3, and Kext refers to the extinction coefficient, L₁ refers to a length of the long optical path, L₂ refers to a length of the short optical path, Cv refers to a volume concentration of solid particles.

Step 5: Process calculation of the solid content based on the new extinction value and the gradation data obtained from the above steps.

In specific implementation, the solid content H is calculated according to the following formula:

$$H = {C}_{v} \times ρ = - \frac{[ ln ( \frac{{I}_{1}}{{I}_{0}} ) - ln ( \frac{{I}_{2}}{{I}_{0}} ) ] 2 D}{3 {K}_{ext} ( {L}_{1} - {L}_{2} )} \times ρ$$

Wherein ρ refers to the density of solid particles.

In the formula, the value of D is D[3,2] in the typical value of particle size distribution data, which is 5.013 μm. Kₑₓₜ is an extinction coefficient corresponding to D[3,2] 5.013 μm, based on Mie scattering calculation, it is 2.0015 . . . L₁=3 mm, L₂=2 mm,

$$\frac{{I}_{1}}{{I}_{0}} = 0.75 , \frac{{I}_{2}}{{I}_{0}} = 0.91 .$$

The parameters are brought into the formula to calculate the Cv value, which is 0.000322. According to this embodiment, the test sample is sediment, and the density is taken as a constant of 2.4. When put into the formula, the solid content is 0.000775, usually the unit of solid content is g/L, and the solid content of this test is 0.775 g/L after unit conversion.

The present invention is a method for analyzing and calculating particle size gradation and solid content using optical path difference method in two-phase flow, which belongs to the field of underwater sand content measurement and particle size gradation.

This sand content and particle size gradation monitoring method with optical path difference collects the extinction values at two optical path lengths and the scattered light intensity signal on the detector, and subtracts the short optical path signal from the long optical path signal to obtain a new set of scattered light intensity signals and extinction values. The scattered light intensity signal is the scattering signal of the particle group in the two-phase flow system, including particle size distribution information. The sediment content can be calculated based on the scattered light intensity signal and extinction value. Whether it is the measured scattered light intensity signal of particle gradation or the extinction value signal of measured solid content, they are not affected by window lens contamination, and can realize long-term operation of underwater or atmospheric online monitoring. There is no need to measure the background signal in the pure medium state, and a pure scattered light intensity signal can be obtained.

The above description includes the preferred embodiments of the present invention only and is not intended to be limiting the concept of the present invention. Within the spirit and principle of the present invention, any modifications, equivalent substitutions, improvements, etc., shall be included in the protection scope of the present invention.

What is claimed is:

1. A method utilizing optical path difference in two-phase flow for analytical calculation of particle size gradation and solid content, characterized in that, said method comprises the following steps:
step 1: changing a width of measurement area of a laser particle size analyzer, and during monitoring, collecting extinction values at two different optical path lengths and a scattered light intensity signal on each detector at two different optical path lengths;
step 2: utilizing the scattered light intensity signal with a long optical path to subtract the scattered light intensity signal with a short optical path on each detector to obtain a set of new scattered light intensity signals with background subtracted;
step 3: processing particle size distribution inversion calculations for the set of scattered light intensity signals with background subtracted to obtain gradation data of solid particles;
step 4: processing subtraction of the logarithm of the extinction value of the short optical path from the logarithm of the extinction value of the long optical path to obtain new extinction value related data;
step 5: processing calculation of the solid content based on the new extinction value related data and the gradation data obtained.

2. The method utilizing optical path difference in two-phase flow for analytical calculation of particle size gradation and solid content according to claim 1, characterized in that: in step 2, the new scattered light intensity signals on the detector is calculated by the followings:
$$S = {A}_{1} - {A}_{2} = ( {S}_{1} + B ) - ( {S}_{2} + B ) = {S}_{1} - {S}_{2}$$
wherein A₁ refers to a scattered light intensity signal with long optical path and background on the detector, A₂ refers to a scattered light intensity signal with short optical path and background on the detector, B refers to the background signal, S₁ refers to a scattered light intensity signal with long optical path after the background is subtracted, S₂ refers to a scattered light intensity signal with short optical path after the background is subtracted, S refers to a scattered light intensity signal difference for different optical paths, that is, the new scattered light intensity signal; the new scattered light intensity signal on each detector constitutes a new set of scattered light intensity signals.

3. The method utilizing optical path difference in two-phase flow for analytical calculation of particle size gradation and solid content according to claim 1, characterized in that: in step 4, a specific calculation of the new extinction value is:
▪
▪
▪
wherein I₁ refers to transmitted signal for long optical path, I₂ refers to transmitted signal for short optical path, I₀ refers to the initial light intensity signal, D refers to the surface area mean diameter of the solid particles calculated by the scattered light intensity inversion in step 3, and Kext refers to the extinction coefficient, L₁ refers to a length of the long optical path, L₂ refers to a length of the short optical path, Cv refers to a volume concentration of solid particles.

4. The method utilizing optical path difference in two-phase flow for analytical calculation of particle size gradation and solid content according to claim 3, characterized in that: in step 5, the solid content H is calculated according to the following formula:
$$H = {C}_{v} \times ρ = - \frac{[ ln ( \frac{{I}_{1}}{{I}_{0}} ) - ln ( \frac{{I}_{2}}{{I}_{0}} ) ] 2 D}{3 {K}_{ext} ( {L}_{1} - {L}_{2} )} \times ρ$$
wherein ▪ refers to a density of solid particle.
